(19) United States
(12) Patent Application Publication
(10) Pub. No.: US 2007/0253625 A1
(43) Pub. Date: Nov. 1, 2007

(54) Method for building robust algorithms that classify objects using high-resolution radar signals

(75) Inventor: Gina Ann Yi, Honolulu, HI (US)

Correspondence Address: PROSKAUER ROSE LLP, ONE INTERNATIONAL PLACE, BOSTON, MA, 02110, US

(73) Assignee: BBNT Solutions LLC, Cambridge, MA (US)

(21) Appl. No.: 11/413,508

(22) Filed: Apr. 28, 2006

(51) Int. Cl. G06K 9/62; G06K 9/46

(52) U.S. Cl. 382/228; 382/195; 382/159

(57) ABSTRACT

A system and method are provided for classifying objects using high resolution radar signals. The method includes determining a probabilistic classifier of an object from a high resolution radar scan, determining a deterministic classifier of the object from the high resolution radar scan, and classifying the object based on the probabilistic classifier and the deterministic classifier.

### GOVERNMENT SUPPORT

The government may have certain rights in the invention under Contract No. MDA972-03C-0083.

### BACKGROUND

Radar, and in particular imaging radar, has many and varied applications to security. Imaging radars carried by aircraft or satellites are routinely able to achieve high resolution images of target scenes and to detect and classify stationary and moving targets at operational ranges.

High resolution radar (HRR) generates data sets that have significantly different properties from other data sets used in automatic target recognition (ATR). Even if used to form images, these images do not normally bear a strong resemblance to those produced by conventional imaging systems. Data are collected from targets by illuminating them with coherent radar waves, and then sensing the reflected waves with an antenna. The reflected waves are modulated by the reflective density of the target.

Today's systems use various techniques to classify the stationary targets and the moving targets. Some techniques utilize neural networks, k-nearest neighbors, simple threshold tests, and template-matching.

### SUMMARY

These techniques suffer from several disadvantages. For example, neural networks are frequently trained using a “back-propagation” method that is computationally expensive and can produce sub-optimal solutions. In another example, k-nearest neighbors make classification decisions by computing the distance (in feature space) between an unlabeled sample and every sample in the training data set that is computationally expensive and requires extensive memory capacity to store the samples from the training data set. In a further example, simple threshold tests lack the complexity to accurately classify targets that are difficult to differentiate. In yet another example, template-matching makes classification decisions by computing the distance between a specific representation of an unlabeled sample and that of each class in a library of templates, that suffers from disadvantages similar to those of the k-nearest neighbors technique.

A system and method are provided for classifying objects using high resolution radar signals. The method includes determining a probabilistic classifier of an object from a high resolution radar scan, determining a deterministic classifier of the object from the high resolution radar scan, and classifying the object based on the probabilistic classifier and the deterministic classifier.

The probabilistic classifier can be determined by selecting a feature-set consisting of features extracted from the high resolution radar scan, selecting a probability density function (PDF) and corresponding parameter-values for each feature extracted from the high resolution radar scan, and assembling the probabilistic classifier using the selected feature-set and the selected PDFs and their corresponding parameter-values. The extracted feature-values from the high resolution radar scan can correspond to a known classification class from a training data set and a known set of probabilistic classification features from the training data set. For multistatic systems, the corresponding parameters can include an angular range for the extracted feature-values.

The PDF and the corresponding parameter-values can be selected by modeling a statistical distribution of each feature with a plurality of parametric PDFs. The selection of the PDF and the corresponding parameter-values can further include estimating the corresponding parameter-values using Maximum Likelihood Parameter Estimation and computing a statistic ‘Q’ of the Chi-Squared Test of Goodness-of-Fit for each parametric PDF. The parametric PDF with the lowest value of ‘Q’ and its corresponding parameter-values are selected.

The feature-set consisting of features extracted from the high resolution radar scan can be selected by computing a probabilistic likelihood value from the extracted feature-values for each class using its joint PDF and classifying the extracted feature-values by selecting the class that produces the highest likelihood value. The selection of the feature set can further include determining the classification accuracy rate from the likelihood values.

The probabilistic classifier can be assembled by computing a probabilistic likelihood value from a joint PDF of each class and selecting the PDF that produces the highest likelihood value. The assembly of the probabilistic classifier can further include assigning a level of confidence to the selected PDF, wherein the level of confidence can be determined by an average of classification accuracy rates. For multistatic systems, computing a probabilistic likelihood value can further include using an angular range for the extracted feature-values.

The deterministic classifier of the object can be determined by selecting a feature-set consisting of features extracted from the high resolution radar scan and assembling the deterministic classifier using the selected feature-set. The feature-set consisting of features extracted from the high resolution radar scan can be selected by averaging the extracted feature-values and classifying the averaged value. The deterministic classifier can be assembled by classifying the averaged value, wherein a level of confidence can be assigned to the classification decision.

The classified object can be outputting a classification type to a user, wherein the classification types can include a known set of objects or is simply “unknown.” The set of objects can include a human, a vehicle, or a combination thereof. The object classification type can be determined by assessing outputs of the probabilistic classifier and outputs of the deterministic classifier, wherein the deterministic classifier takes precedence over the probabilistic classifier.

The high resolution radar scan can include bistatic signals or multistatic signals. The high resolution radar scan also includes a plurality of high resolution radar scans.

The present invention provides many advantages over prior approaches. For example, the invention builds classifiers that are simultaneously robust, flexible, and computationally efficient. The invention 1) provides a systematic approach to building algorithms that classify any set of physical objects; 2) is capable of tailoring a classifier to the type of physical configuration of radar-sensors that is used by the system; 3) specifies a method for selecting classification features from any set of potential classification features; 4) requires relatively simple computation, making it suitable for real-time applications; 5) requires relatively small memory-storage; 6) affords flexibility in the number of HRR scans that a classifier can use to make classification decisions, thereby enabling the classifier to perform with greater accuracy whenever more scans are available to make decisions; and 7) describes a method for assigning a “level of confidence” to each decision made.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 shows a system diagram of one embodiment of the present invention;

FIG. 2 is block diagram of the system of the present invention;

FIG. 3A is a block diagram of a probabilistic classifier module of FIG. 2;

FIG. 3B is a block diagram of a deterministic classifier module of FIG. 2;

FIG. 4A shows a detailed level view of a feature set module and a probability density function (PDF) module of FIG. 3A;

FIG. 4B shows a detailed level view of the PDF module of FIG. 4A;

FIG. 4C shows a detailed level view of the feature set module of FIG. 4A;

FIG. 4D shows a detailed level view of a determination module of the feature set module of FIG. 4C;

FIG. 4E shows a detailed level view of an assembly module of FIG. 3A;

FIG. 5A shows a detailed level view of a feature set selection module of FIG. 3B;

FIG. 5B shows a detailed level view of a classification module of FIG. 3B;

FIG. 5C shows a detailed level view of a deterministic classifier assembly module of FIG. 3B;

FIG. 6 shows a detailed level view of an output classification module of FIG. 2;

FIG. 7A shows a detailed level view of a multistatic feature extraction module and PDF selection module;

FIG. 7B shows a detailed level view of the feature set module of FIG. 3A; and

FIG. 7C shows a detailed level view of a multistatic assembly module.

### DETAILED DESCRIPTION OF THE INVENTION

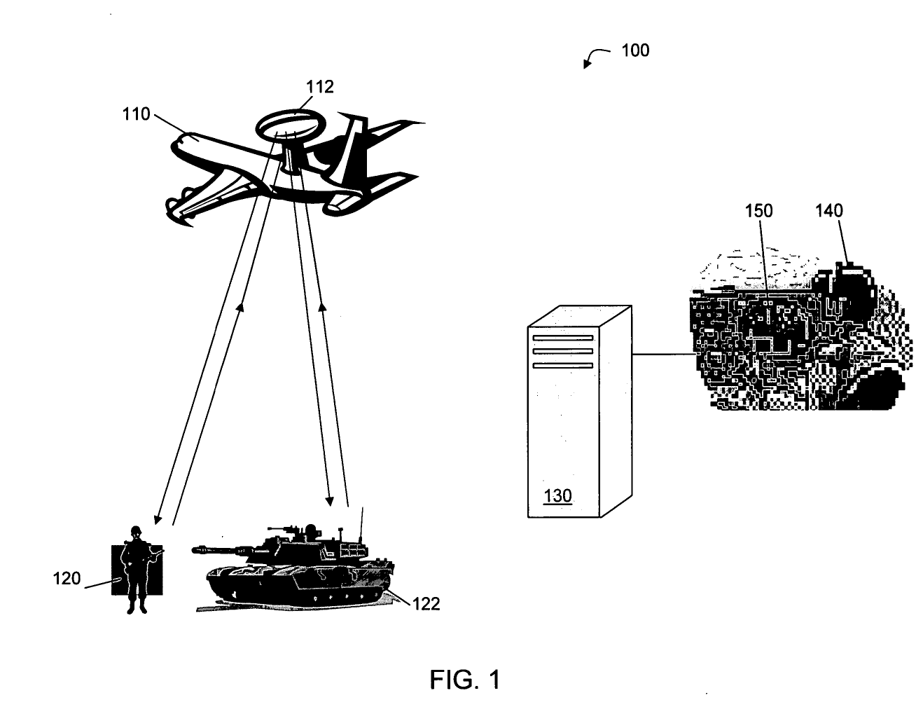

FIG. 1 shows a general diagram of a system 100 for building robust algorithms that classify objects using High-Resolution Radar (HRR) signals. Generally, an aircraft 110 or other vehicle carrying an imaging type radar system 112 scans a search area/grid with radar signals. The radar or scan signals are reflected off objects (120,122) within the grid and received at the radar system 112. These objects can include human personnel 120, vehicles 122, buildings, watercraft, and the like. A processor 130 receives the scan signals (sensor data) and determines the presence of target signatures in the sensed data and reliably differentiates targets from clutter. That is, the target signatures/objects are separated from the background and then classified according to their respective classes (i.e. human personnel 120, vehicle 122). The classified objects are output to a user/viewer 140 on a display 150 or like device.

Although the system 100 is shown to use HRR signals, it should be understood the principles of the present invention can be employed on any type of radar signal. Further, the system 100 can be used with a single transmitter-receiver pair (i.e., bistatic systems) or multiple transmitter-receiver pairs (i.e., multistatic systems). Furthermore, the radar system 112 can be stationary or located on any type of vehicle, such as a marine vessel.

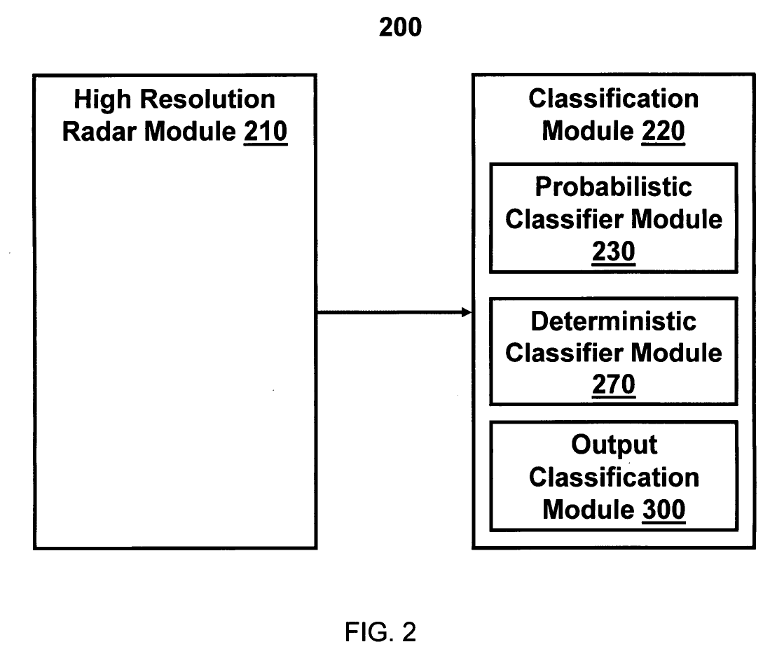

FIG. 2 is block diagram of a system 200 utilizing the principles of the present invention. The system 200 includes a high resolution radar (HRR) module 210 and a classification module 220. The HRR module 210 produces a HRR scan that is used by the classification module 220 to classify the objects determined/found in the scan data and output the object classification to a user. The high resolution radar scan includes bistatic signals or multistatic signals and can include data from a plurality of scans. The classification module includes a probabilistic classifier module 230, a deterministic classifier module 270, and an output classification module 300.

The output module 300 outputs a classification type to a user 140 (FIG. 1). The classification types include a set of objects and “unknown.” As shown in FIG. 1, the set of objects include a human 120 and a vehicle 122. However, it should be understood that the set of objects can be any “known” objects. The classification type is determined by assessing outputs of the probabilistic classifier and outputs of the deterministic classifier, where the deterministic classifier takes precedence over the probabilistic classifier.

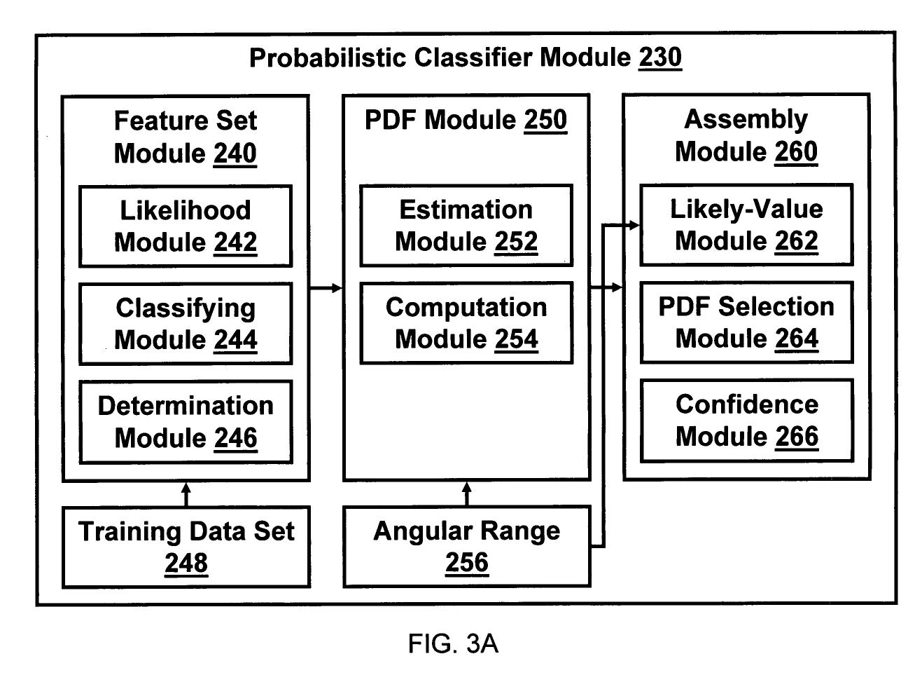

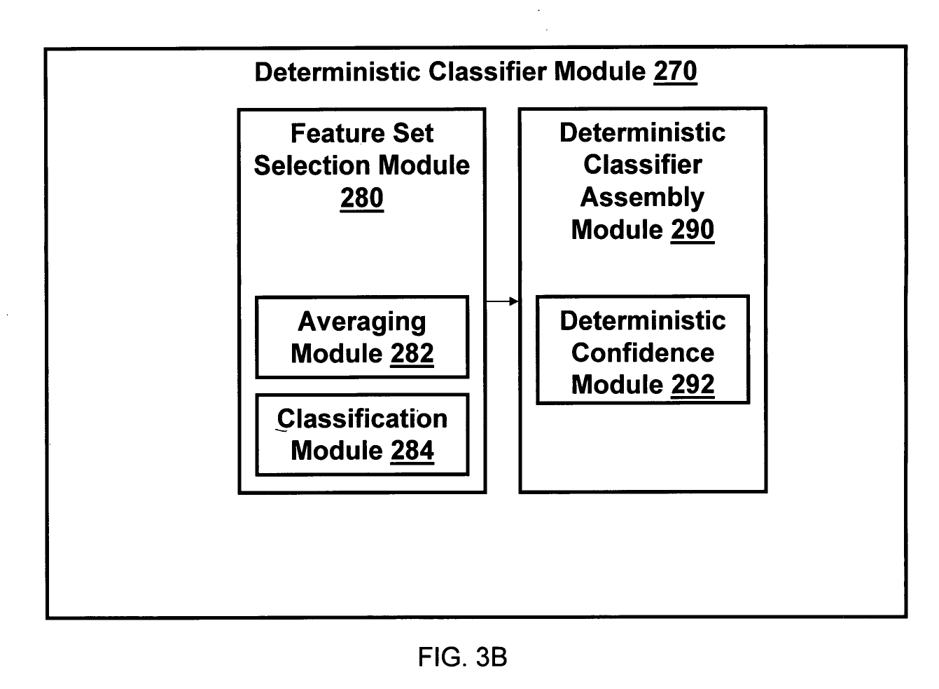

FIG. 3A is a block diagram of the probabilistic classifier module 230 of FIG. 2. The probabilistic classifier module 230 includes a feature set module 240, a probabilistic density function (PDF) module 250, and an assembly module 260. The feature set module selects a feature-set consisting of features extracted from the high resolution scan. The PDF module 250 selects a PDF and corresponding parameter-values for each feature extracted from the high resolution radar scan. The assembly module 260 assembles the probabilistic classifier using the selected feature-set and the selected PDFs and their corresponding parameter-values.

The extracted feature-values from the high resolution radar scan correspond to a known classification class from a training data set 248 and a known set of probabilistic classification features from the training data set 248. The training data set 248 includes the following user specified data: 1) a set of classification “classes” that correspond to objects; 2) sets of deterministic and probabilistic classification “features,” respectively; 3) a set of univariate parametric probability density function (PDF) models; 4) a set of natural numbers that correspond to the number of HRR scans (i.e., “scan-count”); 5) a set of percentages corresponding to classification accuracy rates associated with the set of scan-counts; and 6) a set of angular ranges, each of which corresponds to an aspect-angle “bin,” that contiguously span the range.

The feature-set module includes a likelihood module 242, a classifying module 244, and a determination module 246. The likelihood module 242 computes a probabilistic likelihood value from the extracted feature-values for each class using its joint PDF. The classifying module 244 classifies the extracted feature-values by selecting the class that produces the highest likelihood value. The determination module 246 determines the classification accuracy rate from the likelihood values.

The PDF module 250 models a statistical distribution of each feature with a plurality of parametric PDFs. The PDF module 250 includes an estimation module 252 and a computation module 254. The estimation module 252 estimates the corresponding parameter-values using Maximum Likelihood Parameter Estimation. For multistatic systems, the corresponding parameters include an angular range for the extracted feature-values. The computation module 254 computes a statistic ‘Q’ of the Chi-Squared Test of Goodness-of-Fit for each parametric PDF. The parametric PDF with the lowest value of ‘Q’ and its corresponding parameter-values are selected as the PDF.

The assembly module 260 includes a likelihood value module 262, a PDF selection module 264, and a confidence module 266. The likelihood value module 262 computes a probabilistic likelihood value from a joint PDF of each class. For multistatic systems, likelihood value module 262 further utilizes the angular ranges for the extracted feature-values when computing the probabilistic likelihood value. The PDF selection module 264 selects the PDF that produces the highest likelihood value. The confidence module 266 assigns a level of confidence to the selected PDF. The level of confidence is determined by an average of classification accuracy rates from the training data set 248.

FIG. 3B is a block diagram of a deterministic classifier module 270 of FIG. 2. The deterministic classifier module 270 includes a feature-set selection module 280 and a deterministic classifier assembly module 290. The feature-set selection module 280 selects a feature-set consisting of features extracted from the high resolution radar scan. The deterministic classifier assembly module 290 assembles the deterministic classifier using the selected feature-set.

The feature-set selection module 280 includes an averaging module 282 and a classification module 284. The averaging module 282 averages the extracted feature-values. The classification module 284 classifies the averaged value. The deterministic classifier assembly module 290 includes a deterministic confidence module 292 for assigning a level of confidence to the classification decision.

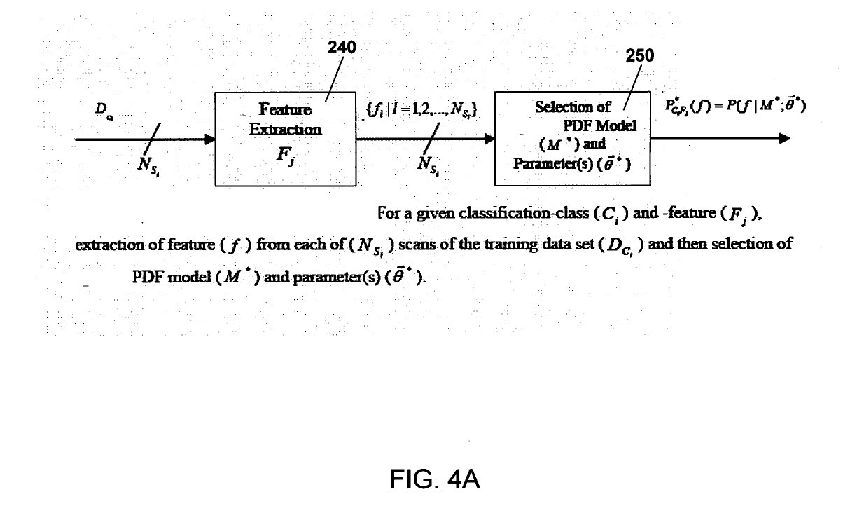

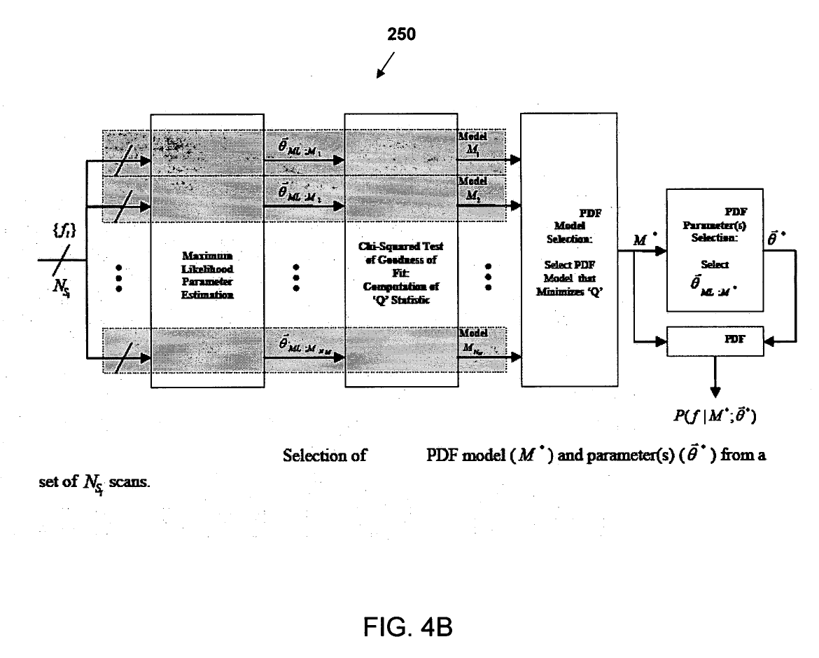

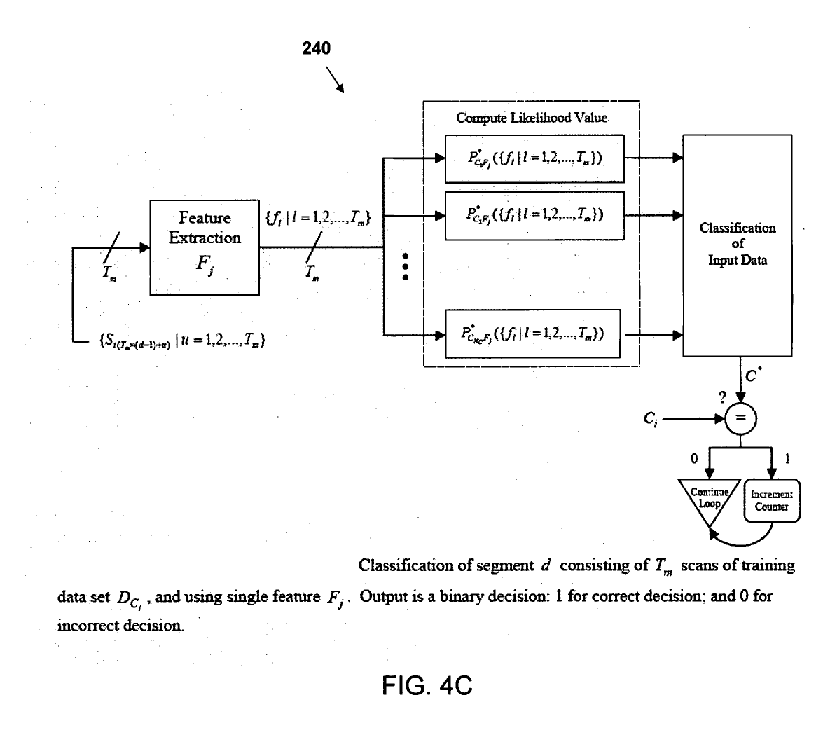

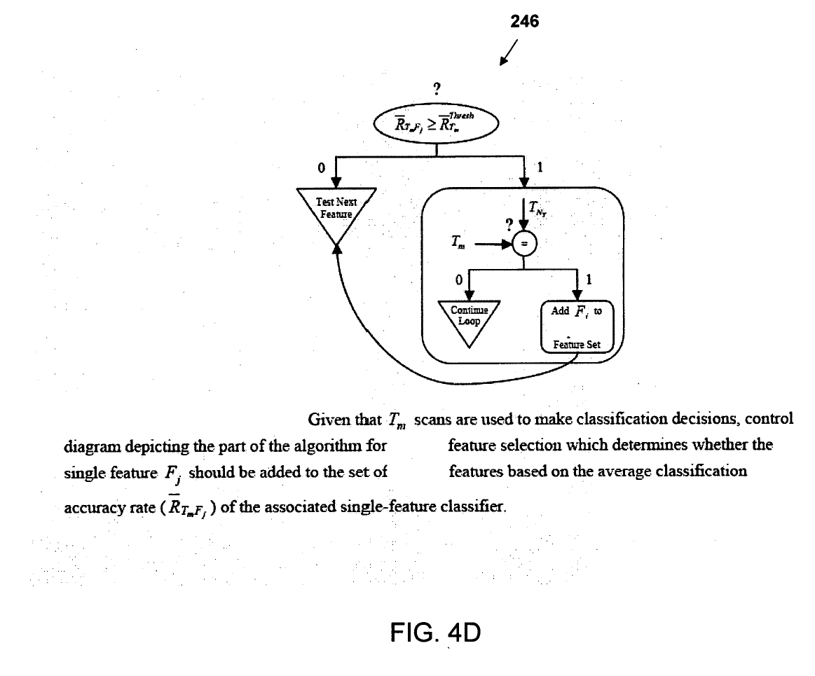

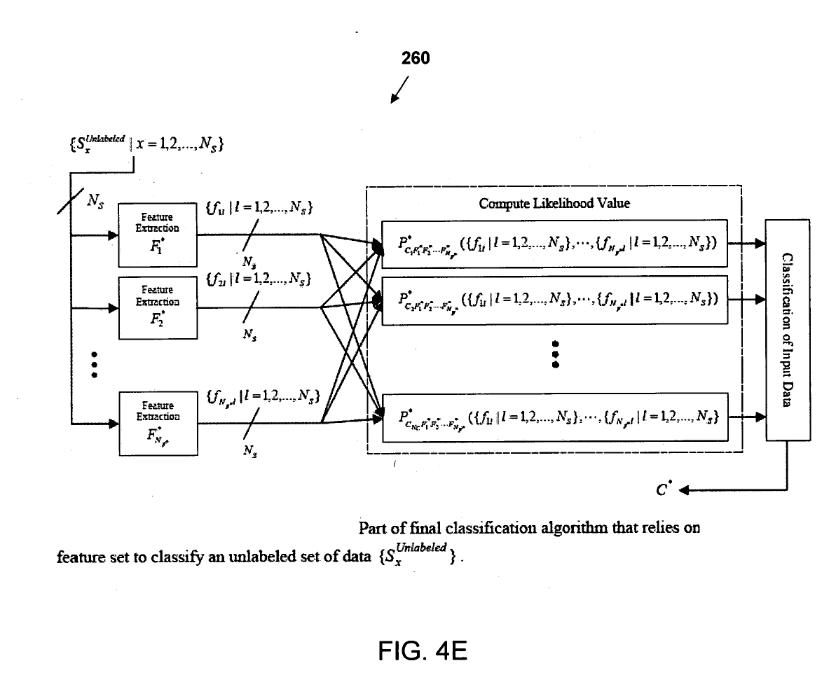

FIGS. 4A-4E show a detailed view of the probabilistic classifier module 230 of FIG. 3A. The probabilistic classifier applies to bistatic HRR systems. However, as explained below, the addition of an angular component to the corresponding parameters allows the probabilistic classifier to be used for multistatic systems.

The probabilistic classifier is built in three stages: (1) selection of the PDF model and the corresponding parameter(s) for each class of each feature; (2) selection of the feature-set; and (3) assembly of the probabilistic classifier using the PDF-models, corresponding parameters, and the feature-set identified in stages one and two as shown above.

As shown in FIGS. 4A and 4B, the first stage selects the PDF model (M*) and corresponding parameter(s) (θ*) for each class of each feature. For example, given a class Cᵢ and a probabilistic feature Fⱼ, a training data set D_{C}_{ᵢ} associated with the class Cᵢ is inputted into a feature extraction block 240 that outputs a value of feature Fⱼ for each of the N_{S}_{ᵢ} scans in the data set. These feature-values are inputted into the PDF model and parameter(s) block 250 that outputs the PDF model and parameter(s).

FIG. 4B shows a detailed level view of the PDF module 250 of FIG. 4A that is used to select the PDF model and corresponding parameters. The marginal distribution of the feature is modeled with each of the N_{M} univariate parametric PDF models. For each model, associated parameters are estimated using Maximum Likelihood Parameter Estimation. A statistic ‘Q’ of the Chi-Squared Test of Goodness-of-Fit is computed to measure how closely that model fits the data. The PDF model is declared to be the model that yields the lowest value of Q and the corresponding parameters are declared to be the Maximum Likelihood Estimates for the corresponding PDF model.

FIG. 4C shows a detailed level view of the feature set module 240 of FIG. 3A. The second stage selects the N_{F*} features of the probabilistic classifier that are denoted by {F*ⱼ|j=1, 2, N_{F*}}. The feature Fⱼ is selected if a single-feature classifier uses the feature Fⱼ and the scan-count Tₘ to classify the training data 248 (FIG. 3A) and the single-feature classifier meets or exceeds the classification accuracy rate specified by the user for each scan-count. For a given feature Fⱼ and scan-count Tₘ, the classification accuracy rate of the associated single-feature classifier is the average of the respective classification accuracy rates produced when the probabilistic classifier is tested on the training data sets 248 from all of the classes. The classification accuracy rate of the single-feature classifier (that uses feature Fⱼ and scan-count Tₘ to make classification decisions) when tested on the training data set D_{C}_{ᵢ} of class Cᵢ is computed by segmenting the data set into N_{J}=└^{N}_{S}_{ᵢ}/_{Tm}┐ samples denoted by {J_{d}|d=1, 2, . . . , N_{J}}. Each sample is labeled with a classification decision. A counter Y, which tallies correct classification decisions made by the single-feature classifier, is initialized to zero. The Tₘ scans of a single sample are inputted into the feature extraction block of FIG. 4C, and the feature extraction block outputs the value of feature Fⱼ for each scan.

The feature-values are inputted into a compute likelihood value block 242 (FIG. 3A) that computes the probabilistic likelihood of the sample. The joint PDF of class Cₙ for feature Fⱼ over Tₘ scans is defined to be the product of the marginal PDF of class Cₙ for the feature Fⱼ over each of the Tₘ scans. The likelihood-values from all of the classes are inputted into a classification of input data block that outputs a classification decision C*.

The classification decision C* is made by selecting the class whose PDF model produces the highest likelihood-value and is correct if the selected class is identical to the actual class Cᵢ to which the sample belongs. Each time a correct decision is made, the counter Y is incremented. When all N_{J} samples have been labeled by the single-feature classifier, an associated classification accuracy rate R is determined by computing the percentage of samples correctly classified (i.e., by dividing Y by N_{J} and multiplying the result by 100%). The classification accuracy rate R is computed for each class' set of training data D_{C}_{ᵢ}. The classification accuracy rates from all classes are averaged to produce R̅_{T}_{ₘ}_{F}_{ⱼ}.

The method for selecting the feature-set requires that each feature Fⱼ be tested against an optimality criterion within a loop. This optimality criterion requires that R̅_{T}_{ₘ}_{F}_{ⱼ} be computed for each scan-count Tₘ within a loop nested inside the loop over the feature Fⱼ. Finally, R̅_{T}_{ₘ}_{F}_{ⱼ} for a given scan-count is computed by computing R for each class' training data set D_{C}_{ᵢ} within a loop nested inside the loop over the scan-count.

FIG. 4D shows a detailed level view of a determination module 246 of the feature set module of FIG. 3A. The procedure is used inside the second loop described in the preceding paragraph (i.e., the loop over each scan-count) to determine whether the feature Fⱼ should be added to the feature-set. The procedure compares R̅_{T}_{ₘ}_{F}_{ⱼ} against a user-specified threshold in the training set for the classification accuracy rate associated with scan-count Tₘ (i.e., against R̅_{T}_{_{m′}}^{Thresh}). If the single-feature classifier for the feature Fⱼ produces a classification accuracy rate R̅_{T}_{ₘ}_{F}_{ⱼ} that meets or exceeds the classification accuracy rate threshold R̅_{T}_{_{m′}}^{Thresh}, for each of the N_{T} scan-counts {T_{m|m=}1, 2, . . . , N_{T}}, then Fⱼ is added to the set of features.

FIG. 4E shows a detailed level view of an assembly module 260 of FIG. 3A. The third stage assembles the probabilistic classifier for bistatic systems using the PDF-models, corresponding parameters, and the feature-set from stages one and two as described above. To classify a sample consisting of unlabeled scans, the probabilistic classifier extracts the set of features {F*ⱼ|j=1, 2, . . . , N_{F*}} from each scan in the feature extraction blocks. All feature-values for each scan are inputted into the compute likelihood value block that computes a probabilistic likelihood of the sample.

The joint PDF of class Cₙ for features {F*ⱼ|j=1, 2, . . . , N_{F*}} over Tₘ scans is defined to be the product of the joint PDF of class Cₙ over Tₘ scans for each of the N_{F*} features. The joint PDF of class Cₙ for the feature F*ⱼ over Tₘ scans is defined to be the product of the marginal PDF of class Cₙ for feature F*ⱼ over each of the Tₘ scans. The likelihood-values from all of the classes are inputted into the classification of input data block that outputs the classification decision C*.

The classification decision C* is made by selecting the class whose PDF model produces the highest likelihood-value. A “level of confidence” is assigned to the decision and is determined by computing the average of the classification accuracy rates produced by the probabilistic classifier when it is tested on the training data set from each of the N_{C} classes using Tₘ scans to make classification decisions.

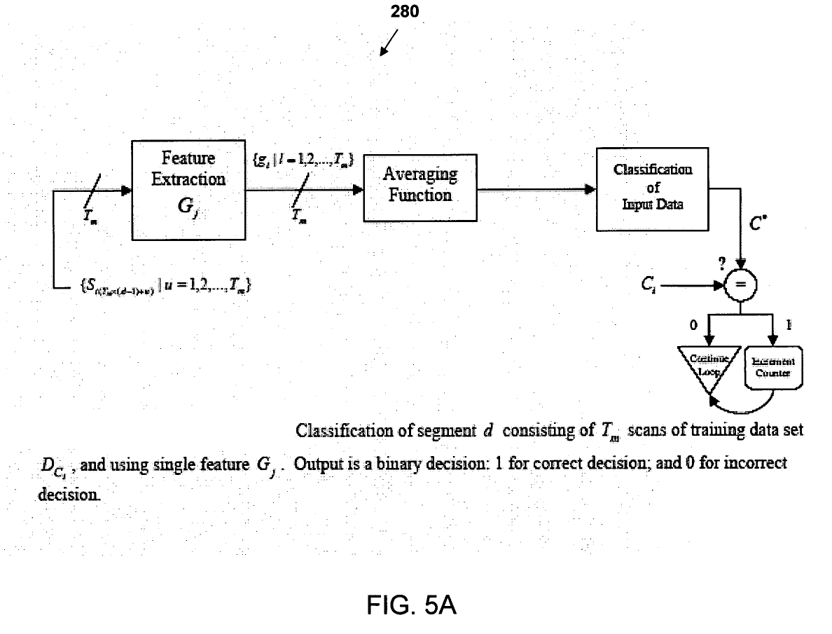

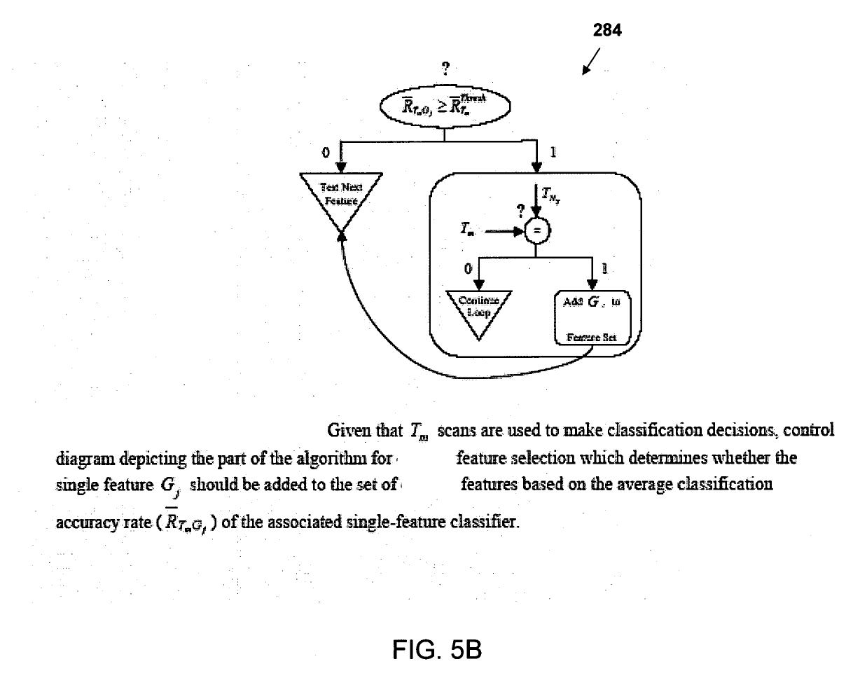

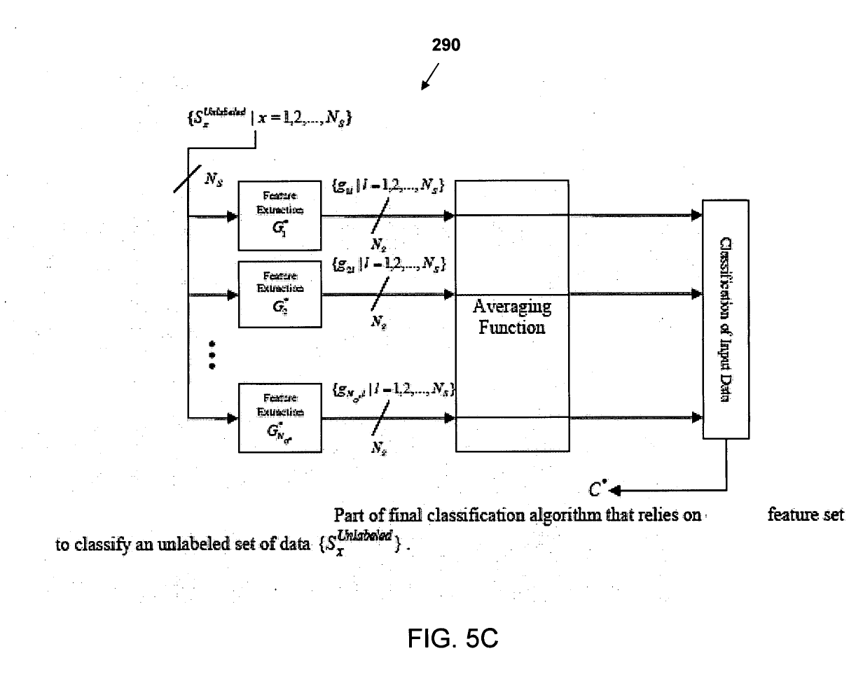

FIGS. 5A-5C show a detailed view of the deterministic classifier module 270 of FIG. 3B. The deterministic classifier applies to both bistatic and multistatic HRR systems. The deterministic classifier is built in two stages: (1) selection of the feature-set; and (2) assembly of the deterministic classifier using the feature-set identified in stage one as described above.

FIG. 5A shows a detailed level view of a feature set selection module 280 of FIG. 3B. The first stage selects the N_{G*} features of the deterministic classifier that are denoted by {G*ⱼ|ⱼ=1, 2, . . . , N_{G*}}. The procedure for selecting the features for the deterministic classifier is similar to the procedure for the probabilistic classifier except that the single-feature classifier corresponding to feature Gⱼ for the deterministic classifier extracts the value of the feature Gⱼ for each scan in the feature extraction block; averages the feature-values in the averaging function block using a user-specified averaging function; and classifies the sample in the classification of input data block according to user-specified classification rules (e.g., threshold tests) for that feature.

FIG. 5B shows a detailed level view of a classification module 284 of FIG. 3B. The procedure is used to determine whether the feature Gⱼ should be added to the feature-set.

FIG. 5C shows a detailed level view of a deterministic classifier assembly module 290 of FIG. 3B. The second stage assembles the deterministic classifier using the feature-set that was identified in the previous stage. To classify an unlabeled sample consisting of one or more scans, the deterministic classifier extracts the set of features {G*ⱼ|ⱼ=1, 2, . . . , N_{G*}} from each scan in the feature extraction blocks. The feature-values for each feature G*ⱼ are inputted into the averaging function block. The averaging function block averages the feature-values using the user-specified averaging function. The average feature-value for each feature is inputted into the classification of input data block that outputs the classification decision C*.

The classification decision C* is made according to user-specified classification rules for the feature-set. A “level of confidence” is assigned to the decision, and is determined by computing the average of the accuracy rates produced by the deterministic classifier when it is tested on the training data set from each of the N_{c} classes using Tₘ scans to make classification decisions.

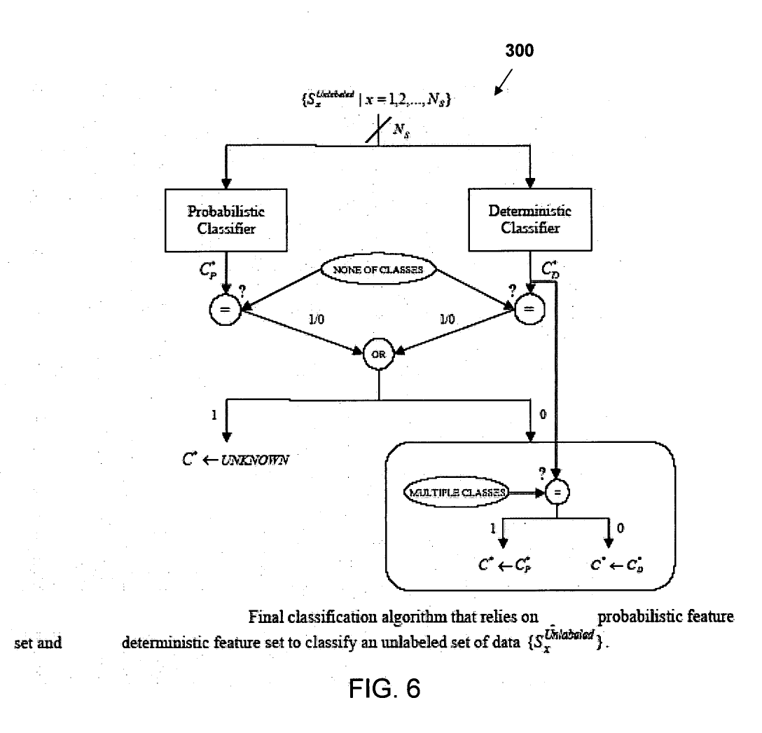

FIG. 6 shows a detailed level view of an output classification module 300 of FIG. 2. The composite classifier combines the probabilistic classifier and deterministic classifier to make classification decisions. The composite classifier outputs a classification decision that is either one of the set of classes {Cᵢ|=1, 2, . . . , N_{c}} or “unknown” if the object corresponding to the unknown sample is identifiable or unidentifiable by the classifier, respectively.

To classify an unlabeled sample consisting of one or more scans, the composite classifier inputs the data from that sample into both the probabilistic classifier and deterministic classifier blocks that make component classification decisions, C*_{P} and C*_{D}, respectively. The composite classifier checks whether either of the component decisions (C*_{P} and C*_{D}) is equal to “none of classes.” “None of classes” indicates that the sample is unidentifiable.

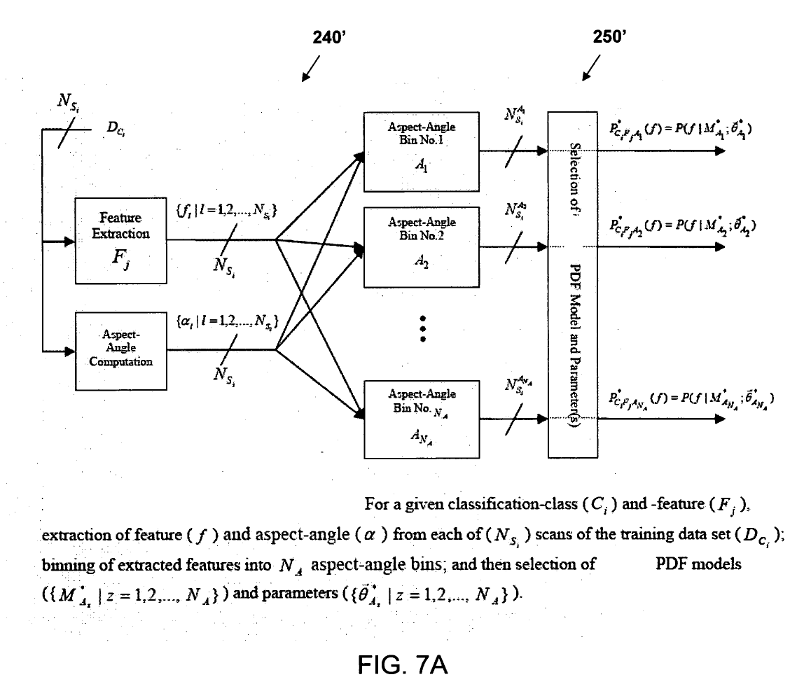

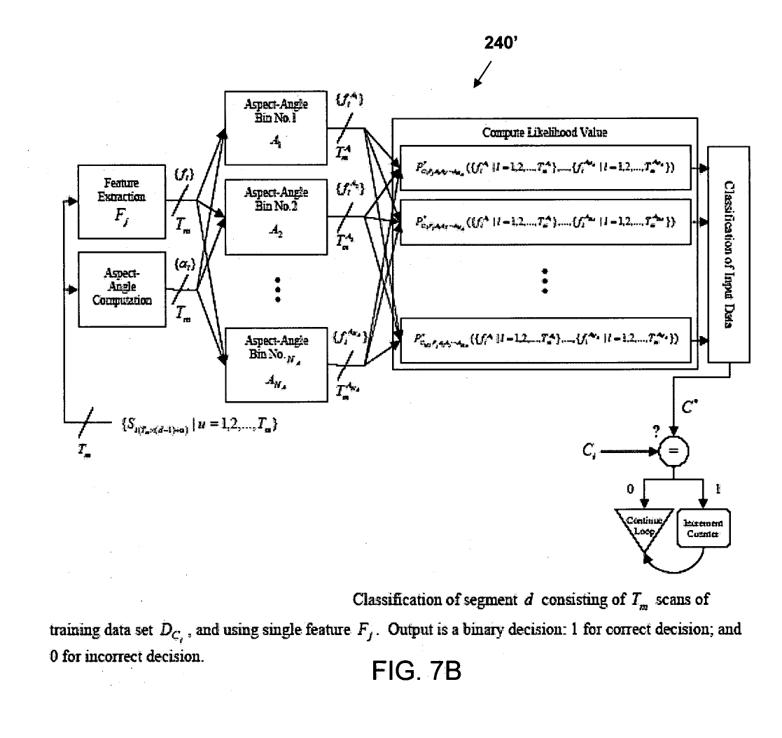

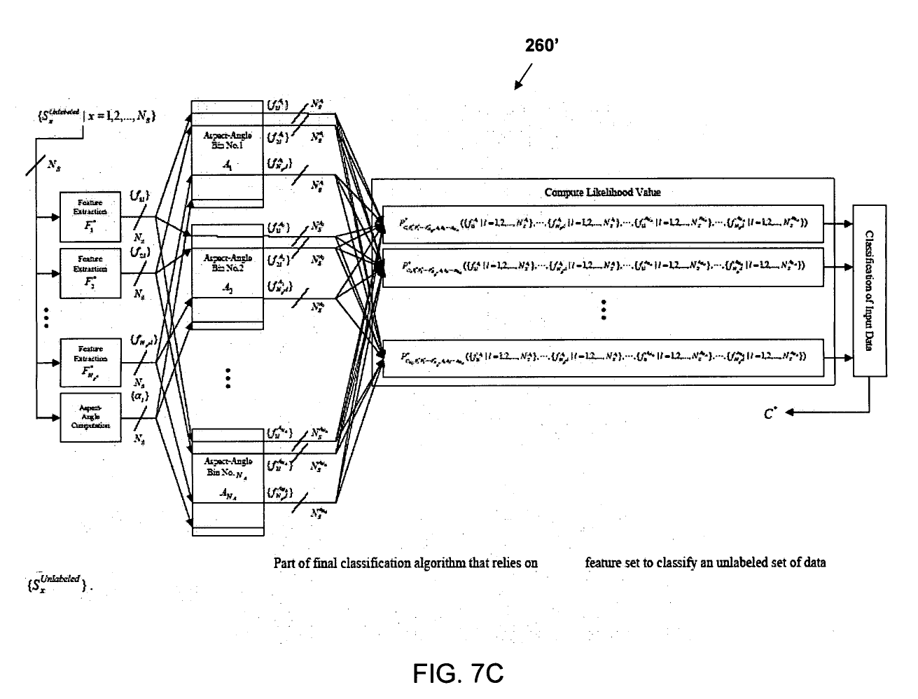

The probabilistic classifier outputs “none of classes” if and only if all of the computed probabilistic likelihood values outputted by the compute likelihood value block (FIG. 4E for bistatic systems and FIG. 7C for multistatic systems) are less than a user-specified threshold. The deterministic classifier outputs “none of classes” in cases that are determined by the user-specified classification rules. For example, to build a deterministic classifier that assigns a label of “human,” “vehicle,” or “none of classes” to an object, the user may specify the following rule: if the velocity of the target is greater than the maximum velocity of either a human or a vehicle (e.g., greater than fifty-three meters per second), then assign “none of the classes” to the object. If either of the component decisions is “none of classes,” the composite classifier labels the sample with the classification decision “unknown.”

If neither of the component decisions is “none of classes,” then the component decision made by the deterministic classifier has precedence if C*_{D} is not equal to “multiple classes.” “Multiple classes” indicates that the sample can be labeled with more than one of the identifiable classes. If C*_{D} is not equal to “multiple classes,” then the composite classifier labels the sample with the decision C*_{D}. However, if C*_{D} is equal to “multiple classes,” then the composite classifier labels the sample with the component decision made by the probabilistic classifier C*_{P}. The deterministic classifier outputs “multiple classes” in cases that are determined by the user-specified classification rules. In the example given in the preceding paragraph, the user may specify the following rule: if the velocity of the target lies within a range over which both humans and vehicles can reasonably travel (e.g., the range of zero to six meters per second), then assign “multiple classes” to the object.

FIGS. 7A-7C show a detailed view of an alternate embodiment of the probabilistic classifier module 230 of FIG. 3A. The alternate/multistatic probabilistic classifier applies to multistatic HRR systems.

The multistatic probabilistic classifier is built in three stages: (1) selection of the PDF model and corresponding parameter(s) for each class of each angular range (i.e., aspect-angle “bin”) of each feature; (2) selection of the feature-set; and (3) assembly of the multistatic probabilistic classifier using the PDF-models, corresponding parameters, and the feature-set identified in stages one and two as described above.

FIG. 7A shows a detailed level view of a multistatic feature extraction module 240′ and PDF selection module 250′. The first stage selects the PDF model (M*) and corresponding parameter(s) (\vec{θ}) for each class of each angular range of each feature. For example, given the class Cᵢ and probabilistic feature Fⱼ, the training data set D_{C}_{ᵢ} associated with class Cᵢ is inputted into the feature extraction and the aspect-angle computation blocks. Each block respectively outputs the value of the feature Fⱼ and the aspect-angle for each of the Nₛ_{ᵢ} scans in the data set. These feature-values and aspect-angle-values are inputted into the N_{A} aspect-angle bin blocks that correspond to the set of angular ranges {A_{n|n=}1, . . . , N_{A}} and which bin the feature-values extracted according to their respective aspect-angles.

The feature-values from each aspect-angle bin are inputted into the PDF model and parameter(s) block. The PDF model and parameter(s) block outputs the PDF model and parameter(s) for that bin. The method for selecting the PDF model and parameters for a multistatic system is identical to the method for selecting the PDF model and parameters for a bistatic system as is explained above with reference to FIG. 4B.

FIG. 7B shows a detailed level view of feature set module 240′ of FIG. 3A. The second stage selects the N_{F}* features of the classifier that are denoted by {F*ⱼ|j=1, 2, . . . , N_{F*}}. The procedure for selecting the features for the multistatic probabilistic classifier is identical to the procedure for the bistatic probabilistic classifier, except that the single-feature classifier corresponding to the feature Fⱼ for the multistatic probabilistic classifier extracts both the value of the feature Fⱼ and the aspect-angle for each scan in the feature extraction and aspect angle computation blocks, respectively; bins the feature-values according to their respective aspect-angles in the N_{A} aspect-angle bin blocks; computes the probabilistic likelihood of the sample; and defines the joint PDF of class Cₚ for feature Fⱼ over all Tₘ scans and their respective angular ranges to be the product of the marginal PDF of class Cₚ of associated angular range Aₙ for feature Fⱼ over each of the Tₘ scans. The procedure used to determine whether the feature Fⱼ should be added to the feature-set is identical to the procedure shown with reference to FIG. 4D.

FIG. 7C shows a detailed level view a multistatic assembly module 260′. The third stage assembles the multistatic probabilistic classifier using the PDF-models, corresponding parameters, and the feature-set that was identified in the two previous stages. To classify an unlabeled sample consisting of one or more scans, the multistatic probabilistic classifier extracts the set of features {F*ⱼ|j=1, 2, . . . , N_{F*}} and aspect-angle from each scan in the feature extraction and aspect-angle computation blocks, respectively. All feature-values are binned according to their respective aspect-angles in the N_{A} aspect-angle bin blocks. The binned feature-values are inputted into the compute likelihood value block that computes the probabilistic likelihood of the sample. The joint PDF of class Cₚ for features {F*ⱼ|j=1, 2, . . . , N_{F*}}, over all Tₘ scans and their respective angular ranges is defined to be the product of the joint PDF of class Cₚ, over all Tₘ scans and their respective angular ranges, for each of the N_{F*} features. The joint PDF of class Cₚ for the feature F*ⱼ over all Tₘ scans and their respective angular ranges is defined to be the product of the marginal PDF of class Cₚ of associated angular range Aₙ for the feature F*ⱼ over each of the Tₘ scans. The likelihood-values from all of the classes are inputted into the classification of input data block that outputs the classification decision C*.

The classification decision C* is made by selecting the class whose PDF model produces the highest likelihood-value. A “level of confidence” is assigned to the decision and is determined by computing the average of the classification accuracy rates produced by the multistatic probabilistic classifier when it is tested on the training data set from each of the N_{C} classes using Tₘ scans to make classification decisions.

Alternative methods for classifying objects could use other types of data/signals. For example, an alternative method could use 2D digital images or videos instead of HRR signals. However, 2D digital images or videos that have sufficient resolution to classify objects could require substantially more computation and memory-storage from the computing system.

Other alternative methods could account for the dependence between classification features and/or the dependence between HRR scans. Such methods could also require substantially more computation and memory-storage from the computing system.

The above-described processes can be implemented in digital electronic circuitry, or in computer hardware, firmware, software, or in combinations of them. The implementation can be as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps can be performed by one or more programmable processors executing a computer program to perform functions of the invention by operating on input data and generating output. Method steps can also be performed by, and apparatus can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Data transmission and instructions can also occur over a communications network. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the above described processes can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The above described processes can be implemented in a distributed computing the system that includes a back-end component, e.g., as a data server, and/or a middleware component, e.g., an application server, and/or a front-end component, e.g., a client computer having a graphical user interface and/or a Web browser through which a user can interact with an example implementation, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing the system can include clients and servers. A client and server are generally remote from each other and typically interact through a communication network. The relationship of client and server arises by virtue of computer programs running on the respective computers and having a client-server relationship to each other.

Unless explicitly stated otherwise, the term “or” as used anywhere herein does not represent mutually exclusive items, but instead represents an inclusive “and/or” representation. For example, any phrase that discusses A, B, or C can include A, B, C, AB, AC, BC, and ABC. In many cases, the phrase A, B, C, or any combination thereof is used to represent such inclusiveness. However, when such phrasing “or any combination thereof” is not used, this should not be interpreted as representing a case where “or” is not the “and/or” inclusive case, but instead should be interpreted as a case where the author is just trying to keep the language simplified for ease of understanding.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for classifying objects using high resolution radar signals, comprising:
determining a probabilistic classifier of an object from a high resolution radar scan;
determining a deterministic classifier of the object from the high resolution radar scan; and
classifying the object based on the probabilistic classifier and the deterministic classifier.

2. The method of claim 1, wherein the step of determining the probabilistic classifier includes:
selecting a feature-set consisting of features extracted from the high resolution radar scan;
selecting a probability density function (PDF) and corresponding parameter-values for each feature extracted from the high resolution radar scan; and
assembling the probabilistic classifier using the selected feature-set and the selected PDFs and their corresponding parameter-values.

3. The method of claim 2, wherein the corresponding parameters include an angular range for the extracted feature-values.

4. The method of claim 2, wherein the extracted feature-values from the high resolution radar scan correspond to a known classification class from a training data set and a known set of probabilistic classification features from the training data set.

5. The method of claim 2, wherein selecting the PDF and the corresponding parameter-values includes modeling a statistical distribution of each feature with a plurality of parametric PDFs.

6. The method of claim 5, further comprising:
estimating the corresponding parameter-values using Maximum Likelihood Parameter Estimation; and
computing a statistic ‘Q’ of the Chi-Squared Test of Goodness-of-Fit for seach parametric PDF.

7. The method of claim 6, wherein the parametric PDF with the lowest value of ‘Q’ and its corresponding parameter-values are selected.

8. The method of claim 2, wherein selecting the feature-set consisting of features extracted from the high resolution radar scan includes:
computing a probabilistic likelihood value from the extracted feature-values for each class using its joint PDF; and
classifying the extracted feature-values by selecting the class that produces the highest likelihood value.

9. The method of claim 8, further comprising determining the classification accuracy rate from the likelihood values.

10. The method of claim 2, wherein assembling the probabilistic classifier includes:
computing a probabilistic likelihood value from a joint PDF of each class; and
selecting the PDF that produces the highest likelihood value.

11. The method of claim 10, wherein the step of computing a probabilistic likelihood value further includes using an angular range for the extracted feature-values.

12. The method of claim 10, further comprising assigning a level of confidence to the selected PDF.

13. The method of claim 12, wherein the level of confidence is determined by an average of classification accuracy rates.

14. The method of claim 1, wherein determining the deterministic classifier of the object includes:
selecting a feature-set consisting of features extracted from the high resolution radar scan; and
assembling the deterministic classifier using the selected feature-set.

15. The method of claim 14, wherein selecting the features-set consisting of features extracted from the high resolution radar scan includes:
averaging the extracted feature-values; and
classifying the averaged value.

16. The method of claim 14, wherein assembling the deterministic classifier includes classifying the averaged value.

17. The method of claim 16, further comprising assigning a level of confidence to the classification decision.

18. The method of claim 1, wherein classifying the object includes outputting a classification type to a user.

19. The method of claim 18, wherein the classification types include a set of objects and unknown.

20. The method of claim 19, wherein the set of objects include a human and a vehicle.

21. The method of claim 18, wherein outputting the classification type is determined by assessing outputs of the probabilistic classifier and outputs of the deterministic classifier.

22. The method of claim 21, wherein the deterministic classifier takes precedence over the probabilistic classifier.

23. The method of claim 1, wherein the high resolution radar scan includes bistatic signals or multistatic signals.

24. The method of claim 1, wherein the high resolution radar scan includes a plurality of high resolution radar scans.

25. A system for classifying objects using high resolution radar signals, comprising:
a high resolution radar signal module for producing a high resolution radar scan;
a probabilistic classifier module for determining an object from the high resolution radar scan;
a deterministic classifier module for determining the object from the high resolution radar scan; and
an object classification module for classifying the object based on the probabilistic classifier and the deterministic classifier.

26. The system of claim 25, wherein the probabilistic classifier module includes:
a feature-set module for selecting a feature-set consisting of features extracted from the high resolution radar scan;
a probability density finction (PDF) module for selecting a PDF and corresponding parameter-values for each feature extracted from the high resolution radar scan; and
an assembly module for assembling the probabilistic classifier using the selected feature-set and the selected PDFs and their corresponding parameter-values.

27. The system of claim 26, wherein the corresponding parameters include an angular range for the extracted feature-values.

28. The system of claim 26, wherein the extracted feature-values from the high resolution radar scan correspond to a known classification class from a training data set and a known set of probabilistic classification features from the training data set.

29. The system of claim 26, wherein the PDF module models a statistical distribution of each feature with a plurality of parametric PDFs.

30. The system of claim 29, further comprising:
an estimation module for estimating the corresponding parameter-values using Maximum Likelihood Parameter Estimation; and
a computation module for computing a statistic ‘Q’ of the Chi-Squared Test of Goodness-of-Fit for each parametric PDF.

31. The system of claim 30, wherein the parametric PDF with the lowest value of ‘Q’ and its corresponding parameter-values are selected.

32. The system of claim 26, wherein the feature-set module:
a likelihood module for computing a probabilistic likelihood value from the extracted feature-values for each class using its joint PDF; and
a classifying module for classifying the extracted feature-values by selecting the class that produces the highest likelihood value.

33. The system of claim 32, further comprising a determination module for determining the classification accuracy rate from the likelihood values.

34. The system of claim 26, wherein the assembly module:
a likelihood value module for computing a probabilistic likelihood value from a joint PDF of each class; and
a PDF selection module for selecting the PDF that produces the highest likelihood value.

35. The system of claim 34, wherein the likelihood value module further includes using an angular range for the extracted feature-values.

36. The system of claim 34, further comprising a confidence module for assigning a level of confidence to the selected PDF.

37. The system of claim 36, wherein the level of confidence is determined by an average of classification accuracy rates.

38. The system of claim 25, wherein the deterministic classifier module includes:
a feature-set selection module for selecting a feature-set consisting of features extracted from the high resolution radar scan; and
a deterministic classifier assembly module for assembling the deterministic classifier using the selected feature-set.

39. The system of claim 38, wherein the features-set selection module includes:
an averaging module for averaging the extracted feature-values; and
a classification module for classifying the averaged value.

40. The system of claim 38, wherein the deterministic classifier assembly module includes classifying the averaged value.

41. The system of claim 40, further comprising a deterministic confidence module for assigning a level of confidence to the classification decision.

42. The system of claim 25, wherein the object classification module includes an output module for outputting a classification type to a user.

43. The system of claim 42, wherein the classification types include a set of objects and unknown.

44. The system of claim 43, wherein the set of objects include a human and a vehicle.

45. The system of claim 42, wherein outputting the classification type is determined by assessing outputs of the probabilistic classifier and outputs of the deterministic classifier.

46. The system of claim 45, wherein the deterministic classifier takes precedence over the probabilistic classifier.

47. The system of claim 25, wherein the high resolution radar scan includes bistatic signals or multistatic signals.

48. The system of claim 25, wherein the high resolution radar scan includes a plurality of high resolution radar scans.

49. A computer readable medium whose contents cause a computer system to classifying objects using high resolution radar signals, the computer system performing the steps of: determining a probabilistic classifier of an object from a high resolution radar scan; determining a deterministic classifier of the object from the high resolution radar scan; and classifying the object based on the probabilistic classifier and the deterministic classifier.

50. A method for classifying objects using high resolution radar signals, comprising:
means for determining a probabilistic classifier of an object from a high resolution radar scan;
means for determining a deterministic classifier of the object from the high resolution radar scan; and
means for classifying the object based on the probabilistic classifier and the deterministic classifier.
